(19) United States
(12) Patent Application Publication
(10) Pub. No.: US 2014/0123158 A1
(43) Pub. Date: May 1, 2014

(54) MOLD FOR TAPE-SHAPED OPTICAL RECORDING MEDIUM, TAPE-SHAPED OPTICAL RECORDING MEDIUM, AND CUTTING DEVICE THEREFOR

(71) Applicants: Yoshifumi Makino, Okayama (JP); Mitsuhiro Tanaka, Okayama (JP); Kenji Takehana, Okayama (JP)

(72) Inventors: Yoshifumi Makino, Okayama (JP); Mitsuhiro Tanaka, Okayama (JP); Kenji Takehana, Okayama (JP)

(73) Assignee: PANASONIC CORPORATION, Osaka (JP)

(21) Appl. No.: 14/128,418

(22) PCT Filed: Jul. 26, 2012
(86) PCT No.: PCT/JP2012/004780

§ 371 Date: Dec. 20, 2013

(30) Foreign Application Priority Data
Aug. 30, 2011 (JP) 2011-187206

(51) Int. Cl. G11B 7/003; G11B 3/00

(52) U.S. Cl. CPC G11B 7/0031; G11B 3/00
USPC 720/746; 83/72; 425/335

(57) ABSTRACT

There is provided a mold for a tape-shaped optical recording medium with which precise cutting can be performed along a cutting guide groove, the mold forming a recording groove in a tape-shaped optical recording medium, and having a plurality of recording and reproduction bumps that form a recording and reproduction groove, and a guide whose shape is different from that of the recording and reproduction bumps.

### TECHNICAL FIELD

The present invention relates to a mold used for manufacturing a tape-shaped optical recording medium equipped with a recording and reproduction groove on the surface of a film, and to a tape-shaped optical recording medium and a cutting device used for the same.

### BACKGROUND ART

In the past, a magnetic tape was manufactured by vapor depositing or sputtering a metal thin-film on a film substrate, and then cutting this product to a specific tape width to match the finished size.

For example, Patent Literature 1 discloses a tape-shaped optical recording medium (metal thin-film type of magnetic tape) that was cut to its finished size by this slitting method.

### CITATION LIST

### Patent Literature

Patent Literature 1: Japanese Laid-Open Patent Application S58-45623

### SUMMARY

### Technical Problem

However, a problem that was encountered with conventional slitting methods for simply cutting to a tape width was that it was difficult to make an accurate cut with respect to the recording and reproduction groove (groove used for the tracking signal) formed in the tape-shaped optical recording medium. Accordingly, a decrease in cutting accuracy during slitting was a factor that adversely affected the quality of the recording signal and tracking performance of the manufactured tape-shaped optical recording medium.

In view of this, it is an object of the present invention to solve the above problem by providing a mold for a tape-shaped optical recording medium, a tape-shaped optical recording medium, and a cutting device for the same, with which the amount of tape meander during cutting can be reduced, allowing very accurate cutting with respect to the recording and reproduction groove.

### Solution to Problem

To achieve the stated object, the mold for a tape-shaped optical recording medium of the present invention is a mold for a tape-shaped optical recording medium which forms recording and reproduction grooves in a recording medium, the mold comprising a plurality of recording and reproduction bumps that form the recording and reproduction grooves, and a guide whose shape is different from that of the recording and reproduction bumps.

As for the shape of the guide being different from that of the recording and reproduction bumps, this refers to a shape in which the optical reflectivity is different from that of the recording and reproduction groove on the tape-shaped optical recording medium side where the mold guide has been transferred. More specifically, for example, this includes cases in which the height (thickness) of the convex portion of the guide is different, or the guide is concave and has a different shape, or the concave and convex shapes of the guide are different, from that of the recording and reproduction bumps.

### Advantageous Effects

With the above configuration, a tape-shaped optical recording medium manufactured with a mold having a guide will have transferred to it a guide for preventing meander during cutting. Thus, accurate cutting with respect to the recording and reproduction groove can be performed by cutting the tape-shaped optical recording medium to the desired width along this guide.

### BRIEF DESCRIPTION OF DRAWINGS

FIG. 1 is a cross section of the shape of the surface of the mold pertaining to Embodiment 1 of the present invention;

FIG. 2 is a cross section of an optical tape formed with the mold in FIG. 1;

FIG. 3 is a cross section of the state when a groove has been transferred to the surface of the optical tape by the mold in FIG. 1;

FIG. 4 is a simplified oblique view of the configuration of a slitter pertaining to Embodiment 2 of the present invention;

FIG. 5 is a cross section of the slitter in FIG. 4;

FIG. 6 is a cross section of the shape of the surface of the mold pertaining to another embodiment of the present invention; and

FIG. 7 is a cross section of an optical tape formed with the mold in FIG. 6.

### DESCRIPTION OF EMBODIMENTS

An embodiment of the present invention will now be described through reference to the drawings.

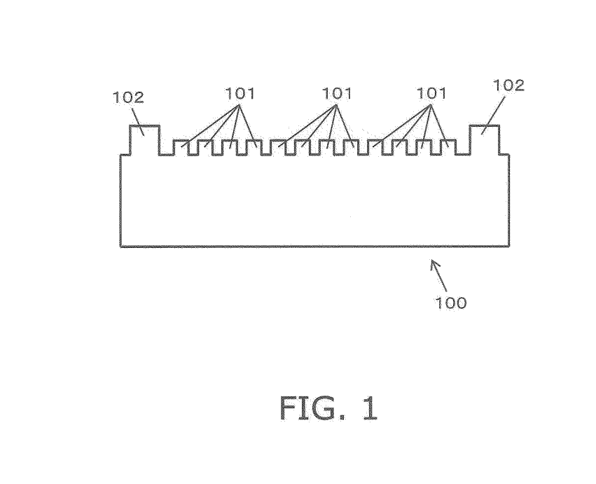

FIG. 1 is a cross section of the surface of a mold 100 (mold for a tape-shaped optical recording medium).

The mold 100 is a roll-shaped mold (such as a stamper roll) that is used to form a recording and reproduction groove in the surface of an optical tape 200, and comprises recording and reproduction bumps 101 and cutting guide bumps (guides) 102. The mold 100 can be used to manufacture one or more long optical tapes.

The recording and reproduction bumps 101 are 100 to 300 nm wide and 20 to 50 nm tall, and a plurality of them are formed on the mold 100. The cutting guide bumps 102 are 500 to 1000 nm wide and 200 to 400 nm tall, and are formed at both outside ends in the width direction of the mold 100, so as to sandwich the recording and reproduction bumps 101.

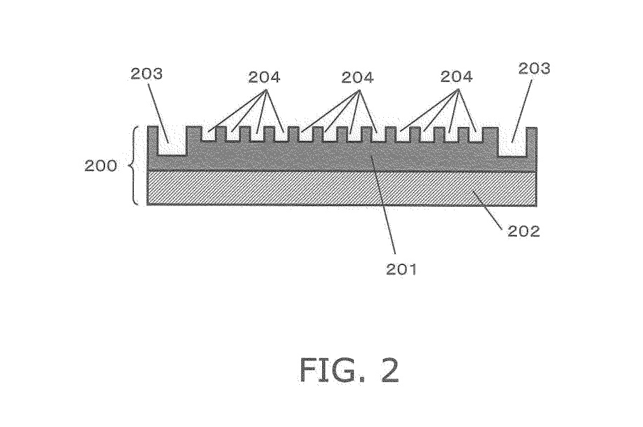

FIG. 2 is a cross section of the optical tape 200 (tape-shaped optical recording medium).

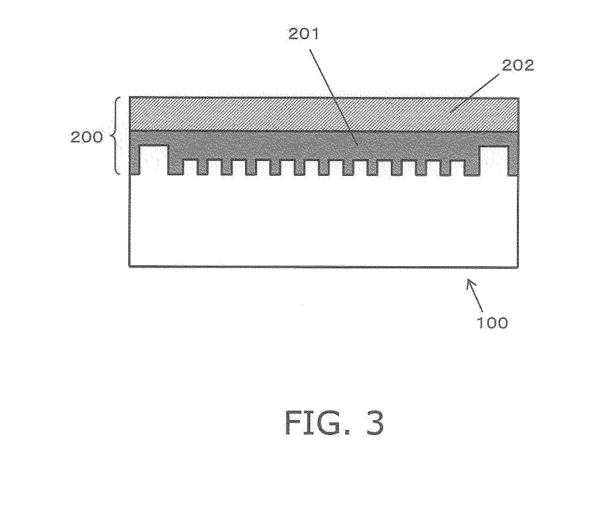

The optical tape 200 is a long recording medium that comprises a UV curable resin 201 and a base film 202. As shown in FIG. 3, the optical tape 200 is manufactured by curing the UV curable resin 201 by irradiating it with UV (ultraviolet) rays from the base film 202 side in a state in which the UV curable resin 201 and the base film 202 are in contact with the mold 100 while being conveyed in a specific direction.

Consequently, the UV curable resin 201 forms cutting guide grooves 203 and recording and reproduction grooves 204, which were transferred from the mold 100, in the surface of the optical tape 200.

With the mold 100 in this embodiment, in addition to the recording and reproduction bumps 101, the surface is also provided with the cutting guide bumps 102 parallel to the recording and reproduction bumps 101. The cutting guide bumps 102 have a shape that is different from the shape of the recording and reproduction bumps 101.

Consequently, in the optical tape 200 formed by the mold 100, the recording and reproduction grooves 204 are transferred to the portion corresponding to the recording and reproduction bumps 101, and the cutting guide grooves 203 are transferred to the portion corresponding to the cutting guide bumps 102.

With the optical tape 200, when the recording and reproduction grooves 204 and the cutting guide grooves 203 are irradiated with light from the same direction, there is a major change in the optical reflectivity, so the position of the cutting guide grooves 203 can be easily detected, without them being mistaken for the recording and reproduction grooves 204. Therefore, in cutting the optical tape 200 to its finished size, it is possible to cut accurately along the recording and reproduction grooves 204. As a result, there is less meander of the tape with respect to the recording and reproduction grooves 204, so tracking performance and recording signal quality are improved.

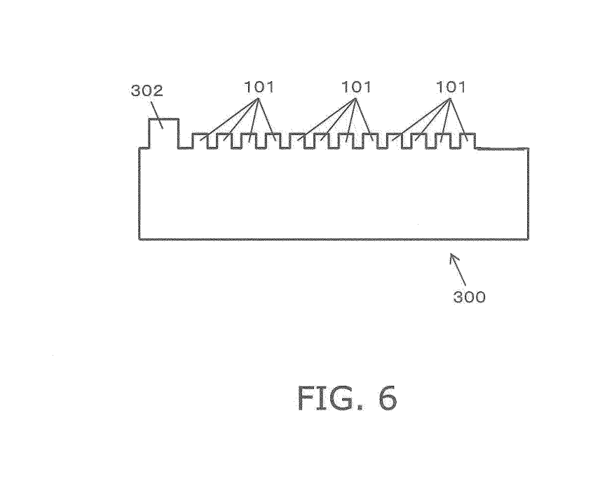

The same effect as in this embodiment can also be obtained by provided a single cutting guide bump 102 on just one side (see FIG. 6; discussed below). In this embodiment, the cutting guide bumps 102 were provided at both ends of the mold 100, but may also be provided at a suitable spacing. For example, the cutting guide bumps 102 may be provided to match the spacing of the blades of the slitter (cutting device; discussed below).

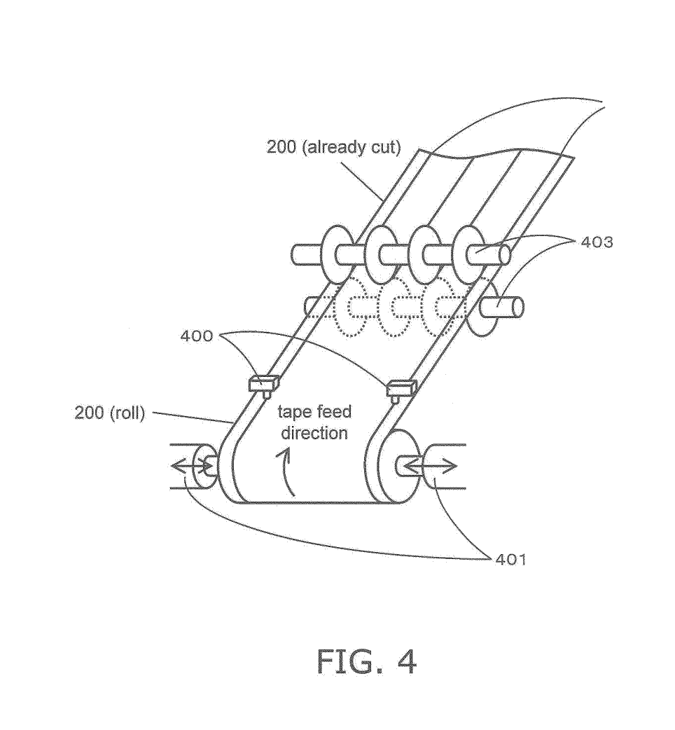

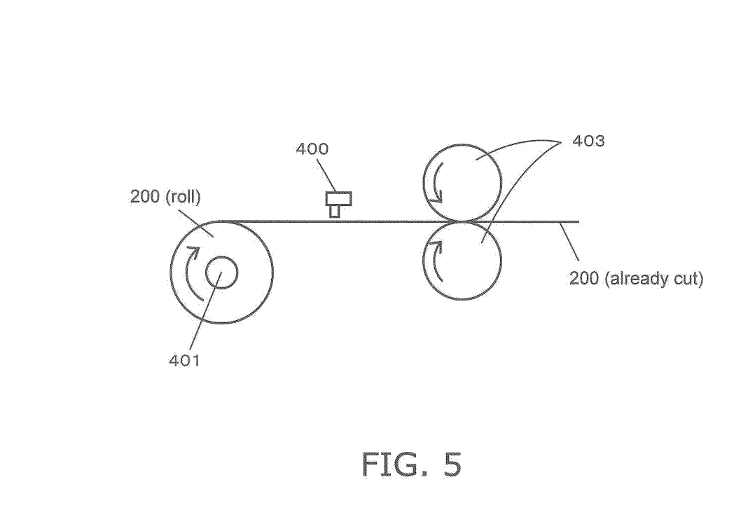

FIG. 4 is a simplified diagram of the slitter (cutting device) used to cut the optical tape 200 manufactured with the mold 100. FIG. 5 is a cross section of this.

The slitter in this embodiment differs from a conventional slitter in that it further comprises a guide groove detector 400 for detecting the cutting guide grooves 203 formed in the optical tape 200, and an actuator 401 for controlling movement in the axial direction of the roll of optical tape 200, in order to control the position where the optical tape 200 is cut.

With this slitter, when the optical tape 200 is inserted in the tape feed direction, the guide groove detector 400 detects the cutting guide grooves 203 of the optical tape 200. When the cutting guide grooves 203 are detected by the guide groove detector 400, the actuator 401 controls the position of the roll of optical tape 200 in the axial direction on the basis of the position information about the cutting guide grooves 203, and the optical tape 200 is cut by blades 403.

Consequently, the slitter can detect the cutting guide grooves 203 formed at both ends of the optical tape 200 in the width direction, as detected by the guide groove detector 400, while allowing accurate cuts that are parallel to the recording and reproduction grooves 204 of the optical tape 200. Thus, the cut optical tape 200 has less amount of meander during cutting, and has been cut very accurately along the recording and reproduction grooves 204, so an optical tape 200 with good tracking performance can be manufactured.

### Other Embodiments

(A)

In the above embodiments, an example was given in which the cutting guide bumps 102 were provided at both ends of the optical tape 200 that formed the optical tape 200, so as to sandwich the plurality of recording and reproduction bumps 101, but the present invention is not limited to this.

What is important is that the cutting device can detect the position of the tape, so a cutting guide bump 302 may be provided on just one side in the width direction of a mold 300 that forms an optical tape, for example, as shown in FIG. 6.

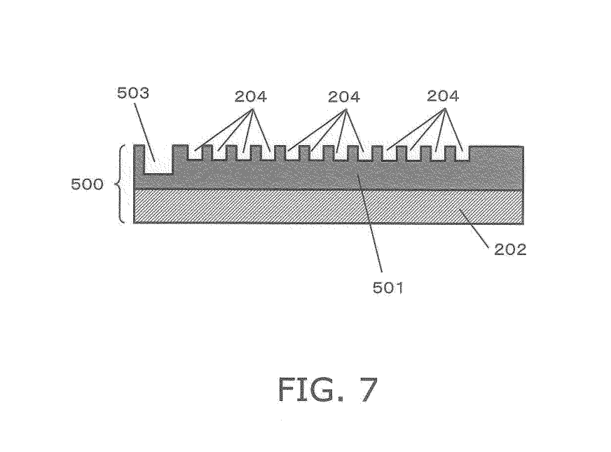

Consequently, as shown in FIG. 7, an optical tape 500 can be obtained that includes a base film 202 and a UV curable resin 501 in which a cutting guide groove 503 is formed on just one side in the width direction.

(B)

In the above embodiments, an example was given in which the cutting guide grooves 203 provided as guides were formed as a continuous groove, but the present invention is not limited to this.

What is important is that the position of the tape can be detected by detecting that the reflectivity in the cutting guide groove is different from that in the recording and reproduction groove, so a stamper roll or other such mold may be used to form the guide as dots, a non-continuous groove, or a bump shape, for example.

(C)

In the above embodiments, an example was given in which the actuator 401 was used as a means for moving the optical tape 200 roll in the axial direction, but the present invention is not limited to this.

For example, the roll of optical tape 200 may be moved in the axial direction by using a tilted roll instead of the actuator 401.

### INDUSTRIAL APPLICABILITY

The present invention has the effect of providing an optical tape with good tracking performance by accurately cutting the tape with respect to the recording and reproduction groove, which is accomplished by cutting a tape-shaped optical recording medium in the desired width along a guide, and therefore can be widely applied to molds used to manufacture tape-shaped optical recording media.

### REFERENCE SIGNS LIST

100 mold
101 recording and reproduction bump
102 cutting guide bump (guide)
200 optical tape (tape-shaped optical recording medium)
201 UV curable resin
202 base film
203 cutting guide groove (guide)
204 recording and reproduction groove
300 mold
302 cutting guide bump
400 guide groove detector (detector)
401 actuator
403 blade
500 optical tape (tape-shaped optical recording medium)
501 UV curable resin
503 cutting guide groove (guide)

1. A mold for a tape-shaped optical recording medium, which forms recording and reproduction grooves in a recording medium, the mold comprising:
a plurality of recording and reproduction bumps that form the recording and reproduction grooves; and
a guide whose shape is different from that of the recording and reproduction bumps.

2. The mold for a tape-shaped optical recording medium according to claim 1,
wherein the guide has a convex portion or a concave portion.

3. The mold for a tape-shaped optical recording medium according to claim 1,
wherein the guide is provided at both ends in the width direction so as to sandwich the plurality of recording and reproduction bumps.

4. The mold for a tape-shaped optical recording medium according to claim 1,
wherein a plurality of the guides are provided, and
the plurality of guides are equally spaced.

5. The mold for a tape-shaped optical recording medium according to claim 1,
wherein the guide is provided to a first end in the width direction.

6. A tape-shaped optical recording medium prior to be cut to finished size by a cutting device, the tape-shaped optical recording medium having:
a plurality of recording and reproduction grooves; and
a guide whose optical reflectivity is different from that of the recording and reproduction grooves.

7. The tape-shaped optical recording medium according to claim 6,
wherein the guide has a shape that is different from that of the recording and reproduction grooves.

8. The tape-shaped optical recording medium according to claim 6,
wherein the guide has a convex portion or a concave portion.

9. The tape-shaped optical recording medium according to claim 6,
wherein a plurality of the guides are provided.

10. A cutting device for cutting the tape-shaped optical recording medium according to claim 6, comprising:
a detector that detects a position of the guide; and
a cutter that cuts the tape-shaped optical recording medium along the guide.

11. The cutting device according to claim 10,
further comprising an actuator that moves the tape-shaped optical recording medium, which has been cut by the cutting device, in the width direction on the basis of the detection result of the detector.
